(19) United States
(12) Patent Application Publication
(10) Pub. No.: US 2025/0327924 A1
(43) Pub. Date: Oct. 23, 2025

(54) ON-THE-FLY OPTO-ACOUSTIC MICROSCOPY

(71) Applicant: Onto Innovation Inc., Wilmington, MA (US)

(72) Inventors: Frank Vozzo, Randolph, NJ (US); Robin A. Mair, West Chicago, IL (US); Manjusha Mehendale, Morristown, NJ (US); Marco Alves, Newark, NJ (US); Aishwarya Hegde, Andover, MA (US); George Andrew Antonelli, Flanders, NJ (US)

(73) Assignee: Onto Innovation Inc., Wilmington, MA (US)

(21) Appl. No.: 18/986,601

(22) Filed: Dec. 18, 2024

Related U.S. Application Data
(60) Provisional application No. 63/636,334, filed on Apr. 19, 2024.

(51) Int. Cl. G01S 15/89; G01N 29/275; G01N 29/34

(52) U.S. Cl. CPC G01S 15/8968; G01N 29/275; G01N 29/343; G01N 2291/023; G01N 2291/2697

(57) ABSTRACT

An opto-acoustic measurement device detects and images buried structures in a sample, such as voids or other underlying structures, using a fixed delay time between pulses in the pump beam and pulses in the probe beam, while continuously scanning the sample over multiple measurements locations. The signals acquired at a fixed pump-probe time delay from a plurality of measurements locations has sufficient information and sensitivity to discriminate the presence or absence of a buried structure, such as a void, inclusion or solid structure, in a sample. The pump and probe beams may be focused in a line shaped illumination spot that is oriented orthogonally to that direction of travel during the scan, and a multi-channel linear detector array may detect signals at a plurality of locations along the line shaped illumination spot. Non-acoustic transient perturbations may be detected using two fixed pump-probe delay times.

### CROSS REFERENCE TO RELATED APPLICATIONS

This application claims priority under 35 U.S.C. § 119 to U.S. Provisional Application No. 63/636,334, filed Apr. 19, 2024, entitled “Metrology Based on Time Resolved Non-Acoustic Signals,” which is incorporated by reference in its entirety.

### FIELD OF THE DISCLOSURE

The subject matter described herein is related generally to microscopy, and more particularly to the use of reflectivity and deflection measurements in acoustic microscopy.

### BACKGROUND

Inspection and measurement of materials or products to help ensure the quality of those products is a useful step in manufacturing. The same is true for semiconductor wafers or similar products that include microscopic elements that are not easily measured. Metrology systems have been previously used to make measurements of such wafers. Improvements to those metrology systems, including power consumption, throughput, and performance are advantageous.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Opto-acoustic metrology, in general, uses a pump beam and a probe beam with a varying time delay between light pulses in each of the pump and probe beams. The light pulses in the pump beam produce an acoustic response within the sample under test that propagates to the surface of the sample, which is detected by the probe beam. The acoustic response, for example affects the reflectivity of the material in the sample or deflection of the probe beam. The varying time delay between light pulses is used to generate time resolved reflectance measurements of the sample. Opto-acoustic metrology is useful as it enables the non-destructive detection and measurement of underlying structures in the sample, which may be difficult to otherwise detect. Opto-acoustic metrology, however, is a relatively slow process because at each measurement point the time delay between light pulses must be varied through the range of time delays in order to obtain the time resolved reflectance measurements before moving to the next measurement point and repeating the process. As discussed herein, however, an opto-acoustic metrology device may detect and image underlying structures using a fixed time delay. Accordingly, at each measurement point, the measurement may be acquired using the fixed time delay, thereby avoiding the need to vary the time delay through a range of delays before moving to the next measurement point. Consequently, the measurements may be acquired while continuously moving or scanning the sample, thereby decreasing the amount of time required for measurement and inspection of the sample.

The opto-acoustic metrology device detects and images buried structures in a sample, such as voids or other underlying structures, using a fixed delay time between pulses in a pump beam and pulses in a probe beam, while continuously scanning the sample over multiple measurements locations. The signals acquired at a fixed pump-probe time delay from a plurality of measurements locations has sufficient information and sensitivity to discriminate the presence or absence of a buried structure, such as a void, inclusion or solid structure, in a sample. Accordingly, the use of variable pump-probe delay times at each measurement location is avoided, thereby improving the signal acquisition time. Moreover, the signals may be acquired using a continuous scan, such as a raster scan or radial scan, avoiding the use of conventional discrete move/stop/acquire approach, further improving the signal acquisition time. Line shaped illumination spots oriented orthogonally to the direction of travel may be used along with a multi-channel linear detector array to detect signals at a plurality of locations along the line shaped illumination spot. Additionally, multiple fixed pump-probe delay times may be used, e.g., by splitting the pump beam into a primary and secondary pump beams having different delay times, which may be used to detect and image buried structures based on acoustic or non-acoustic transient perturbations.

In one implementation, a method of characterizing a sample with an opto-acoustic metrology device includes laterally scanning the sample with the opto-acoustic metrology device. A plurality of pump pulses and a corresponding plurality of probe pulses are generated with a fixed pump-probe delay between each pump pulse and probe pulse and the sample is irradiated with the plurality of pump pulses and the corresponding plurality of probe pulses while laterally scanning the sample. Each pump pulse produces a transient perturbation in material in the sample and each probe pulse is reflected from the sample and is modulated by the transient perturbation in the material caused by a preceding pump pulse after the fixed pump-probe delay. Reflected probe pulses are detected from a plurality of measurement locations on the sample while laterally scanning the sample. A characteristic of the sample can then be determined based on variations in the reflected probe pulses from the plurality of measurement locations.

In one implementation, an opto-acoustic metrology device configured for characterizing a sample includes at least one actuator configured to laterally scan the sample with the opto-acoustic metrology device by moving at least one of the sample and the opto-acoustic metrology device. The opto-acoustic metrology device includes a pump arm and a probe arm that generate a plurality of pump pulses and a corresponding plurality of probe pulses with a fixed pump-probe delay between each pump pulse and probe pulse. At least one lens is used to irradiate the sample with the plurality of pump pulses and the corresponding plurality of probe pulses while laterally scanning the sample. Each pump pulse produces a transient perturbation in material in the sample and each probe pulse is reflected from the sample and is modulated by the transient perturbation in the material caused by a preceding pump pulse after the fixed pump-probe delay. The opto-acoustic metrology device includes a detector that detects reflected probe pulses from a plurality of measurement locations on the sample while laterally scanning the sample, and at least one processor that is coupled to the detector and is configured to determine a characteristic of the sample based on variations in the reflected probe pulses from the plurality of measurement locations.

### BRIEF DESCRIPTION OF THE DRAWINGS

FIG. 1 illustrates a schematic representation of an example opto-acoustic metrology device that is configured to perform on-the-fly measurements with a single fixed pump-probe delay, as discussed herein.

FIG. 2 illustrates a block diagram of another example opto-acoustic metrology device that is configured to perform on-the-fly measurements with a single fixed pump-probe delay, as discussed herein.

FIGS. 3A and 3B illustrate linear relative movement of the sample and the optical head to scan the opto-acoustic measurement of the sample.

FIGS. 4A and 4B illustrate rotational relative movement of the sample and the optical head that may be used to scan the opto-acoustic measurement of the sample.

FIGS. 5A and 5B illustrate the detection of buried structures in a sample having one or more metallic layers using two-dimensional scanning of opto-acoustic measurements at a single fixed pump-probe time delay.

FIG. 6 illustrates a pump arm that splits a pump beam into a primary pump beam and a secondary pump beam with two different fixed pump-probe delay times.

FIGS. 7A, 7B, and 7C illustrate the detection of buried structures in a sample having no metallic layers (or other strongly absorbing material capable of producing acoustic signals) using two-dimensional scanning of opto-acoustic measurements at two separate fixed pump-probe time delays to measure non-acoustic transient signals.

FIG. 8, for example, illustrate a plurality of images of a buried structure that is imaged using opto-acoustic measurements with various pump-probe delay schemes and scanning schemes.

FIG. 9 is a flow chart illustrating a process of non-destructively characterizing a sample with an opto-acoustic metrology device using transient signals.

### DETAILED DESCRIPTION

Non-destructive measuring and inspecting techniques may be used to ensure proper processing of semiconductor or other similar devices. For example, during processing, a series of fabrication steps may be performed in which layers, such as insulating layers, polysilicon layers, and metal layers, are deposited and patterned. In another example, during processing advanced packaging processes may be used to interconnect two or more devices during packaging. During processing, e.g., fabrication and packaging, desired or undesired buried structures may be produced in the sample, e.g., structures under one or more layers. A sample can be a wafer, a panel, or any other substrate. The detection or measurement of such structures using non-destructive metrology techniques may be necessary or desirable to ensure proper processing for proper operation of resulting devices and to increase yield.

By way of example, during advanced packaging processes, two or more samples may be bonded together using a number of physical and chemical process techniques. During the bonding process, structures such as solid structures, voids, or inclusions may be intentionally or inadvertently formed between bonded layers. It may be desirable to detect the presence or measure such structures during processing. For example, the structures may be useful to ensure proper alignment of the wafers. Similar to fabrication processing techniques, structures may be formed in a series of processing steps, such as the deposition and patterning of material layers such as insulating layers, polysilicon layers, and metal layers. For proper operation of such devices, the successful formation, patterning, and alignment of successive layers during fabrication and packaging is sometimes crucial. Moreover, inadvertently formed structures may affect the final performance of devices and, accordingly, may adversely affect the overall yield. If undesired characteristics, such as improper alignment or undesired structures, are detected, it may be possible to rework bonded wafers before additional processing is performed, such as polishing, etc.

There are various conventional optical techniques that may be used for non-destructive metrology or inspection of devices during the processing, e.g., during fabrication or packaging. Non-destructive techniques for metrology or inspection of devices during processing, e.g., during fabrication or packaging, often rely on the use of light. For example, conventional techniques may use specific wavelengths of light, e.g., ultraviolet (UV), visible, or infrared (IR), to image or otherwise detect one or more structures produced during processing. Typically, to conventionally detect or image buried structures, e.g., structures that are under one or more layers, light having wavelengths suitable to penetrate the overlying layers is used.

However, conventional optical techniques are sometimes unsuitable for the measurement or detection of buried structures when the structures are under optically opaque layers or the structures are optically transparent to the specific wavelengths of light being employed. In some instances, for example, overlying layers, or the layer in which the structure is formed, may be formed with a material that is opaque to light, e.g., when the material is metal. In such instances, it may not be possible to conventionally image the buried structures. As another example, voids or inclusions may be buried in between layers that are underneath a full layer of silicon (Si), e.g., 750 μm. Such structures may be difficult to detect or image as the structure, e.g., voids or inclusion, is optically transparent to the light. In some instances, infrared imaging may be possible to image such structures, unless the structures are covered by opaque layers, e.g., metal layers. Unfortunately, the resolution of infrared imaging technology is limited, making such techniques generally unsuitable even for voids that are not covered by metal layers.

One type of non-destructive metrology technique that may be used to detect voids is confocal scanning acoustic microscopy (C-SAM), which uses acoustic signals. Unfortunately, for proper conduction of the acoustic signal with C-SAM technology the sample is submerged in water, which is generally undesirable for many samples, such as semiconductor or other similar devices. Moreover, C-Sam technology is not able to image relatively small voids, e.g., sizes below 10 μm, and therefore has limited use.

Opto-acoustic metrology, such as Picosecond Acoustic Microscopy (PAM), in general, may be used to detect and measure buried structures, including voids, inclusions, or solid structures. For example, interfacial voids that are generated during hybrid bonding process, such as chip to chip, chip to wafer, wafer to wafer, and substrate to substrate, may be detected and imaged using opto-acoustic metrology. Conventional opto-acoustic metrology, in general, uses pump beams and probe beams with a varying time delay between light pulses in the pump and probe beams to generate time resolved reflectance measurements. A metrology device that performs time resolved reflectance measurements, for example, may implement a variable time delay between the pump pulses and the probe pulses using a mechanically translating delay line that, e.g., alters the length of the beam path of the pump or probe beam, or using an asynchronous optical sampling (ASOPS) configuration, in which two synchronized light sources, e.g., lasers, with slightly different repetition rates produce the variable time delay without use of a mechanically translating delay line. The light pulses in the pump beam produce an acoustic response within the sample under test that propagates to the surface of the sample, which is detected after a delay by the probe beam. The acoustic response, for example affects the reflectivity of the material in the sample or deflection of the probe beam. The varying time delay between light pulses is used to generate time resolved reflectance measurements of the sample. Opto-acoustic metrology is useful as it enables the non-destructive detection and measurement of underlying structures in the sample, which may be difficult to otherwise detect. Opto-acoustic metrology, however, is a relatively slow process because at each measurement point the time delay between light pulses must be varied through the range of time delays in order to obtain the time resolved reflectance measurements before moving to the next measurement point and repeating the process.

As discussed herein, opto-acoustic metrology systems, such as PAM, use a fixed time delay between pump pulses and probe pulses instead of a varying time delay. Accordingly, at each measurement point, the measurement may be acquired using the fixed time delay, thereby avoiding the need to vary the time delay through a range of delays before moving to the next measurement point. Signals received at a fixed time delay from multiple measurements locations may have sufficient information and sensitivity to discriminate the presence or absence of a buried structure, such as a void, inclusion or solid structure, in a sample. With the use of a fixed time delay instead of a varying time delay, measurement speed and throughput may be increased, while maintaining the desired accuracy of the measurement. By way of contrast, in conventional opto-acoustic metrology acquisition schemes, time varying signals are acquired sequentially at a series of discrete measurement locations on a sample. By mapping appropriate signal attributes (e.g., a specific acoustic feature within the time varying signal) versus location, one may generate a map of the sample revealing buried structures, e.g., sub-surface features or voids. The speed or throughput of the opto-acoustic measurement of a sample using the conventional discrete move/stop/acquire approach is limited by not only individual time varying signal acquisition time, but also by the time associated with incremental move and stop of the sample or metrology head. In contrast, as discussed herein, on-the-fly acquisition approach using a fixed time delay eliminates much of the time required for the discrete move/stop in the conventional approach, and greatly reduces the acquisition time, as the varying time delay is not required, and is limited, in principle, only by the acquisition time required for sufficient signal to noise for individual image pixels.

For the on-the-fly methodology as discussed herein, the opto-acoustic measurement is held at a specified pump-probe delay, which may be selected so as to provide signal differentiation for the buried feature of interest. With the pump-probe delay fixed, imaging scans may be captured rapidly due to relative movement between the sample and the metrology head, e.g., as the sample is moved laterally beneath the metrology head. For example, a raster scan strategy may be employed in which a measurement signal is acquired with a single pump-probe delay while the sample is moved laterally at constant speed in one direction for a specified distance. Then, the sample is moved incrementally in an orthogonal direction to prepare for the next linear move and signal acquisition. The serpentine path continues until measurements have been acquired for the entire region of interest. For a static system, the area of measurement is set by the pump and probe overlap area which can be described by a bounding box of W and H. In what follows, H is the dimension perpendicular to the scan and W the parallel. The effective pixel size along the direction of travel is defined by sample speed(S) and acquisition time (T) required for a single data point, e.g., pixel size=S*T. In the limit as S or T tends to zero, the pixel size will go to W. The pixel size orthogonal to the direction of travel is defined by the raster increment distance (I), which is the spacing between adjacent scan lines. If I is less than or equal to H, the percent overlap between successive scan would be 100*(H−I)/I. If I is greater than H, a gap of I-H will exist between successive scans. Individual pixel acquisition triggers are provided by the moving stage for the sample (or metrology head) and is synchronized with the stage (or head) position. In another implementation, of the on-the-fly measurements, a radial scan is performed. The radial movement of the sample will be performed via coordinated movement of the x/y stage or θ stage. The effective pixel size will be comparable to the raster scan approach, e.g., where the pixel size is determined by the speed of rotation and acquisition time. With a radial scan approach, however, the stage's rotational movement is coordinated and will maintain a constant speed during the scan to ensure a constant acquisition time. Additionally, the radial scan may encompass a large area of the sample, and may require dynamic focusing. With either linear or radial scans, the on-the-fly approach for the opto-acoustic measurement significantly reduces the number of move/stops required to complete a two-dimensional scan over a region of interest.

In some implementations, the on-the-fly approach for opto-acoustic measurements may be performed using a measurement spot size, e.g., focused laser spot size, that is comparable to the effective pixel size (S*T*I). In some implementations, parallelized signal acquisition may be used. In the parallelized signal acquisition scheme, for example, the pump and probe beams may be focused into a narrow line that illuminates the sample surface in a stripe that is orthogonal to the direction of travel. The resulting signals are detected by a multi-channel linear detector array. The illuminated stripe on sample is imaged to the linear detector array. The effective magnification of the optical imaging system and the array detector element size and spacing now define the effective image pixel size (previously I). The effective pixel size parallel to the direction of travel is still defined as S*T. By parallelizing the signal acquisition during the linear or radial scans, the overall on-the-fly image capture rate is further improved by a factor given approximately as the number of detector elements.

The on-the-fly approach for opto-acoustic measurements is compatible with both a homodyne configuration using a single light source that produces light that is split into the pump arm and probe arm, and a heterodyne configuration using two light sources that generate the pump-probe delay, such as asynchronous optical sampling (ASOPS). Systems of both configurations are capable of being set to held at fixed pump-probe delay for the on-the fly measurement. For certain measurement cases it may be advantageous to acquire measurement signals at two or more specified fixed delay times, as described herein.

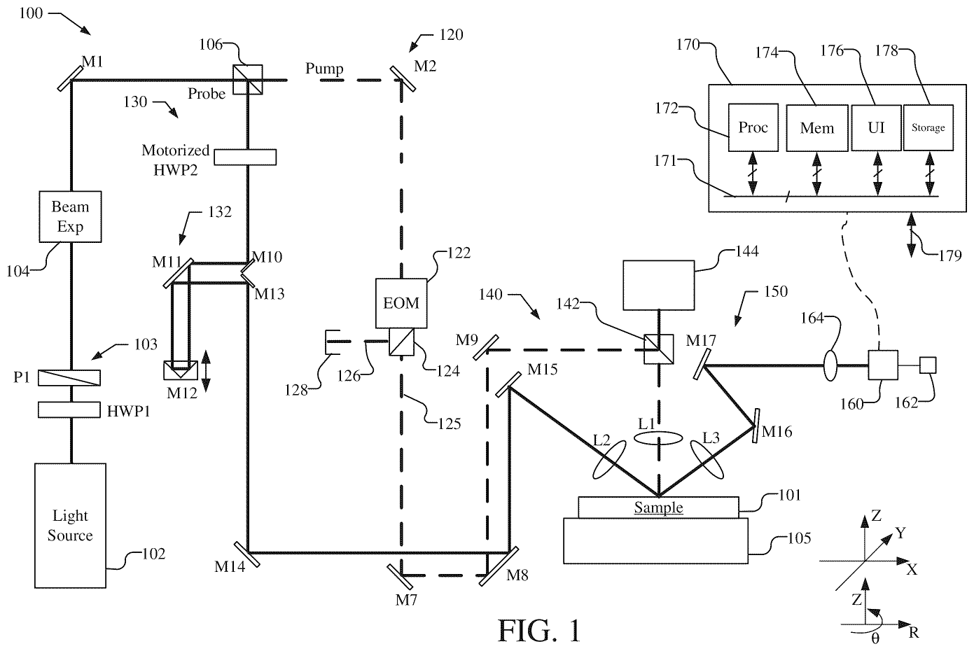

FIG. 1 illustrates a schematic representation of an example opto-acoustic metrology device 100 that is configured to perform on-the-fly measurements with a single fixed pump-probe delay, as discussed herein. The measured signals with fixed time delay from multiple measurements locations, for example, may be used for detecting and imaging buried structures, such as voids, inclusions, and solid structures.

During the on-the-fly measurements with a single fixed pump-probe delay, the sample 101 is laterally scanned, e.g., by producing relative motion between the sample 101 and the optical head 140, which may be generally illustrated as being the focusing unit, but in some implementations may include additional components of or the entirety the metrology device 100. For ease of reference, the scanning of the sample 101 may be described herein as movement of the sample 101 relative to the optical head 140, but it should be understood that scanning of the sample 101 may be performed by any relative movement between the sample 101 and the optical head 140. For example, the sample 101 may be held on a stage 105 that includes or is coupled to one or more actuators configured to move the sample 101 relative to the optical head 140 so that multiple locations in the region of interest on the sample 101 may be measured. The stage 105, for example, may be capable of horizontal motion in either Cartesian (i.e., X and Y) coordinates, or Polar (i.e., R and θ) coordinates or some combination of the two. The stage 105 may also be capable of vertical motion along the Z coordinate.

In one implementation of the on-the-fly measurements, the sample 101 is scanned using a raster scan strategy, e.g., in X and Y coordinates. For example, using a raster scan, the measurement signal is acquired at the fixed pump-probe delay while the sample 101 is moved at constant speed in one direction (in the +X direction) for a specified distance, then moved incrementally in an orthogonal direction (in the Y direction), and then moved at the constant speed in the opposite direction (in the −X direction). The serpentine path continues until measurements have been acquired for the entire region of interest. The effective pixel size along the direction of travel is defined by the sample speed(S) and acquisition time (T) required for a single data point, e.g., pixel size=S*T, as discussed above. The pixel size orthogonal to the direction of travel is defined by the spot size of the pump and probe beams, which may be the raster increment distance (I), which is the spacing between adjacent scan lines.

In another implementation of the on-the-fly measurements, the sample 101 is scanned using a radial scan strategy, e.g., in the R and θ coordinates. For example, using a radial scan, the measurement signal is acquired at the fixed pump-probe delay while the sample 101 is moved at constant rotational velocity (in the θ direction) while also moving in the orthogonal direction (in the R direction). The radial scan may generate a spiral pattern (e.g., by continuous motion in the radial (R) direction) or a series of concentric circles (e.g., by discrete steps in the radial (R) direction) over the region of interest on the sample 101. The radial movement of the sample 101 will be performed via coordinated movement of the X/Y stage or θ stage. For a radial scan, the effective pixel size along the direction of travel (in the θ direction) is defined by the radius (r), the angular velocity (ω), and acquisition time (T) required for a single data point, e.g., pixel size=r*ω*T. The pixel size orthogonal to the direction of travel (in the R direction) is defined by the spot size, which may be equal to the radial increment distance (I), e.g., the spacing between loops of the spiral. With a radial scan approach, the rotational and linear movement is coordinated to maintain a constant angular velocity (ω) and to maintain a constant radial increment distance (I) during the scan to ensure a constant effective pixel size and acquisition time.

If desired, in other implementations of the on-the-fly measurements, the sample 101 may be scanned using scanning strategies other than raster or radial scans. For example, scans may be performed between non-uniform or random sites within a given bounded area on the sample 101. In another example, scans may be performed along lines that are at an angle with respect to a boundary or reference line, where at each boundary the scan line is redirected according to a predetermined rule including but not limited to the angle of incidence with respect to the boundary is equal to the angle of reflection or at an angle, e.g., chosen by the user or experimentation or chosen based on random number. In another example, scans may be performed along an outward or inward curvilinear or rectilinear spiral for a region bounded by an area.

As illustrated, the device 100 includes a light source 102 that produces a light beam that includes a series of light pulses. The light source 102, by way of example, may be laser, such as a 520 nm, 200 fs, 60 MHz laser, but other types of light sources or other characteristics may be used. For example, the device 100 may use light sources that operate in the infrared wavelength ranges, e.g., for imaging buried structures. Additionally, the pulses in the light beam may be produced in various ways, such as by the laser or by an amplitude modulator, including but not limited to a chopper, acoustic-optic modulator (AOM), electro-optic modulator (EOM), etc., which may be external to the laser, but may be considered as part of the light source 102. The light produced by light source 102 may be directed through an intensity control 103, which may include a half wave plate HWP1 and a polarizer P1, and may be directed through a beam expander 104. The beam may be directed by one or more optical elements, such as mirror M1, to beam splitter 106 that splits the light into a pump beam in the pump arm 120 and a probe beam in the probe arm 130.

In the pump arm 120, the pump beam is directed by mirror M2 to a pump beam optical modulator 122. The pump beam optical modulator 122, for example, may be an electro-optic modulator (EOM) or other suitable modulator, to intensity modulate the pump beam at a desired frequency, which may be in the range of several megahertz (MHz), such as about 5 or 5.5 MHz, but other frequencies may also be utilized. The modulated pump beam is received by a pump beam splitter 124. The pump beam splitter 124 splits the modulated pump beam. A portion of the pump beam continues along the pump beam path 125 and the remaining portion of the pump pulse that is routed along waste or rejected pump light path 126 into a waste or rejected pump beam dump 128. A beam dump as used herein is an optical element used to absorb light, such as the rejected pump pulse.

The pump beam is directed by beam steering mirrors, e.g., mirrors M7, M8, and M9, to a focusing unit. At least one of the mirrors M7, M8, and M9 may be attached to a piezoelectric motor to adjust the direction of the pump beam. As illustrated in FIG. 1, the focusing unit may include a beam splitter 142 that directs the pump beam through lens L1 to be normally incident on the sample 101. The lens L1 focuses the pump beam over an area of the sample 101 that includes the structure to be imaged. In some implementations, the pump beam may be directed to be obliquely incident on the sample 101, e.g., along the same beam path as the probe beam, which is focused by lens L2.

In the probe arm 130, after the beam splitter 106, the probe beam may pass through a half wave plate HWP2, which may be motorized to rotate. The probe beam may be directed to an optical delay 132 that includes mirrors M10, M11, M12, and M13. The mirror M12, for example, may be a retroreflector and may be a coupled to an actuator or voice coil that may be controlled to vary the delay of the probe beam with respect to the pump beam. As discussed herein, during measurement of a sample, which the sample 101 is scanned, the delay produced by the optical delay 132 may be fixed so that the delay between the pulses in the primary pump beam and the secondary pump beam is constant. The optical delay 132 may be controlled to set the delay between pulses in the pump beam and pulses in the probe beam, e.g., for best signal sensitivity with respect to the expected depth of the structures to be detected or imaged in the sample. In some implementations, the optical delay 132 may be located in the pump arm 120, e.g., before the optical modulator 122, instead of being in the probe arm 130. In some implementations, separate delays may be located in both the pump arm 120 and the probe arm 130.

The probe beam is directed by beam steering mirrors, e.g., mirrors M14, M8, M15, to the focusing unit. At least one of the mirrors M14, M8, and M15 may be attached to a piezoelectric motor to adjust the direction of the probe beam. As illustrated in FIG. 1, the focusing unit may direct the probe beam through lens L2 to be obliquely incident on the sample 101. The lens L2 focuses the probe beam over an area of the sample 101 that includes the structure to be imaged and may be coincident with the area of incidence of the pump beam. In some implementations, similar to the pump beam, the probe beam may pass through a modulator, e.g., an EOM, followed by a polarizer and a half wave plate, which may be motorized to rotate, to modulate the frequency of the probe beam, e.g., with a different frequency comb than the pump beam.

The lenses L1 and L2, for example, may be configured to irradiate the sample 101 with the pump beam and the probe beam. The pump beam and probe beam may be coincident at the same measurement location on the sample 101. The illumination spot of the pump and probe beams produced by lenses L1 and L2 is scanned over the surface of the sample 101 during measurement by producing relative motion between the sample 101 and the optical system, e.g., using a stage 105 that holds the sample 101, so that various locations on the sample 101 are measured. In some implementations, the spot size produced by the lenses L1 and L2 may be comparable to the effective pixel size produced the continuous relative movement of the sample 101 and optical head 140 of the metrology device 100 during a scan of the sample 101. The effective pixel size along the direction of travel of the scan is defined by the sample speed(S) and acquisition time (T) required for a single data point, e.g., pixel size=S*T, as discussed above. The measurement spot size produced by lenses L1 and L2 parallel to the direction of travel of the scan may be comparably to the effective pixel size (S*T). Additionally, the effective pixel size orthogonal to the direction of travel during the scan is defined by the spot size of the pump and probe beams, which may be equal to the incremental distance (I), e.g., the spacing, between adjacent scan lines. The measurement spot size produced by lenses L1 and L2 orthogonal to the direction of travel of the scan may be comparably to the effective pixel size (I). In some implementations, the lenses L1 and L2 may generate a line shaped illumination spot, with a line width that is comparably to the effective pixel size (S*T) and a line length (I) that is orthogonal to the direction of travel of the scan.

The reflected probe beam (and optionally reflected pump beam if obliquely incident) is received by a collection optics 150 that includes, e.g., lens L3 and mirrors M16 and M17. The reflected beam is directed to a detector 160 via lens 164. The detector 160 may be a photodetector or a multi-pixel array of photodetectors. For example, if a line shaped illumination spot is used, the detector 160 may include a multi-channel linear detector array and the reflected light from the illuminated line is imaged on the linear detector array. An image of the sample 101 may be generated by scanning the sample 101, e.g., by producing relative motion between the sample 101 and the optical head 140, to perform measurements at each separate measurement location during the scan.

The detector 160 may be coupled to a demodulator 162, such as a lock-in amplifier that is configured for phase locking during acquisition of signals. In some implementations, the detector 160 may be a lock-in camera that includes a multi-pixel array and independent phase locking for each pixel in the multi-pixel array. The phase locking is used to demodulate the received probe beam based on the frequency of the intensity modulation of the pump beam, or the combination of frequencies in both the pump beam and probe beam if the probe beam is also modulated. In implementations in which both the pump pulses in the pump beam and probe pulses in the probe beam are modulated with two different frequency combs (e.g., by modulators in both pump arm 120 and probe arm 130), the phase locking may be used to demodulate the combination, e.g., sum or difference, of the frequencies. Moreover, the phase locking may generate in-phase measurements and quadrature measurements from the images. The detector 160 records the reflectance of the sample 101 at the fixed pump-probe delay, and by collecting measurements at a plurality of adjacent locations, changes in the reflectance of the sample 101 at the fixed pump-probe delay may be recorded as a function of position on the sample 101. With the reflectance measurements, the reflectivity or deflection of the sample 101 may be determined as an instantaneous signal difference. The instantaneous signal difference for example, may be a differential reflectivity or change in reflectivity measurement (AR/R), which is a due to the presence of strain and its associated change of the optical constants of the materials in the sample 101, or surface or interface deflection measurement, which is due to the physical deflection of the beam due to the presence of a strain at a surface or interface of the sample 101. It should be understood that for ease of reference, the reflectivity or deflection from the sample collectively may sometimes be referred to herein generally as reflectance.

In addition, the opto-acoustic metrology device 100 may be coupled with a dynamic focus control device 144 that may be configured to dynamically control the focus of the pump and probe beams on the sample 101 during the on-the-fly measurement. The dynamic focus control device 144, for example, may image the top structure of the sample 101 via beam splitter 142 and lens L1, and may dynamically control the height (Z) of the sample with respect to the optical head 140. The dynamic focus control device 144, for example, may be the navigation channel camera. In some implementations, the reflected pump light, which is not used for signal acquisition, or a portion of the probe light, e.g., that is rejected by one of the optical elements, may be detected and the integrated power may be monitored against an expected value to detect changes in focus, which is corrected for the dynamic focus control.

In the depicted implementation, the device may include additional components and subsystems, such as beam management and conditioning components, such as beam expanders, collimators, polarizers, half-wave plates, etc., as well as a beam power detector, and a height detector. Those having skill in the art will appreciate variations of the devices depicted in FIG. 1 that would still be suitable to carry out the reflectance metrology techniques described herein.

The detector 160 and actuators for controlling the relative motion of the sample 101 and the optical head 140, as well as other components of the metrology device 100, may be coupled to a processing system 170, such as a workstation, a personal computer, central processing unit or other adequate computer system, or multiple systems. It should be understood that one processor, multiple separate processors or multiple linked processors may be used, all of which may interchangeably be referred to herein as processing system 170. The processing system 170 is preferably included in, or is connected to, or otherwise associated with metrology device 100. The processing system 170, for example, may control the relative motion of the sample 101 and the optical head 140 during the on-the-fly measurements with a single fixed pump-probe delay, e.g., by controlling movement of the stage 105 on which the sample 101 is held. The processing system 170 may further control the operation of a chuck on the stage 105 used to hold or release the sample 101.

The processing system 170 may collect and analyze the data obtained from the detector 160 and demodulator 162. In some implementations, the processing system 170 may function as the demodulator 162. The processing system 170 may analyze the metrology data from multiple measurement locations to detect and image a buried structure, such as voids, inclusions, and solid structures, in the sample 101. For example, in some implementations, an underlying structure may be detected and imaged based on analysis of the signal difference between measurement locations along the scan to differentiate between various attributes or traits of the transient signals from the different measurement locations. The attributes or traits of the transient signals from different locations may be used to determine whether the measurements are carried out at locations with voids or locations without voids. The transient signals, for example, may be acoustic transient signals or non-acoustic transient signals, i.e., signals in which contributions from any acoustic signal is less than the contributions produced by other physical phenomena such as one or more of thermal dissipation, electron-hole recombination, plasma diffusion, symmetry breaking at top and bottom oxide surfaces, etalon effects, etc. The underlying structures may be detected based on a comparison of the signal difference produced by the transient signals from a plurality of different locations. The processing system 170 may alternatively or additional process the reflectance metrology data for edge detection or triangulation, e.g., using a classification library or neural network generated by the opto-acoustic metrology device 100 (or another device) on a reference sample.

The processing system 170, which includes at least one processor 172 with memory 174, as well as a user interface 176, which may include a display and input devices, such as key board and mouse, which may be interconnected via a bus 171. A non-transitory computer-usable storage medium 178 having computer-readable program code embodied may be used by the processing system 170 for causing the processing system 170 to control the opto-acoustic metrology device 100 and to perform the functions including the analysis described herein. The data structures, software code, etc., for automatically implementing one or more acts described in this detailed description can be implemented by one of ordinary skill in the art in light of the present disclosure and stored, e.g., on a computer-usable storage medium 178, which may be any device or medium that can store code and/or data for use by a computer system such as the at least one processor 172. The computer-usable storage medium 178 may be, but is not limited to, flash drive, magnetic and optical storage devices such as disk drives, magnetic tape, compact discs, and DVDs (digital versatile discs or digital video discs). A communication port 179 may also be used to receive instructions that are used to program the processing system 170 to perform any one or more of the functions described herein and may represent any type of communication connection, such as to the internet or any other computer network. The communication port 179 may further export signals, e.g., measurement or inspection results and/or instructions, to another system, such as external process tools, in a feed forward or feedback process in order to adjust a process parameter associated with a process steps of the samples or provide rework instructions. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described. The results from the analysis of the data may be stored, e.g., in memory 174 associated with the sample and/or provided to a user, e.g., via UI 176, an alarm or other output device.

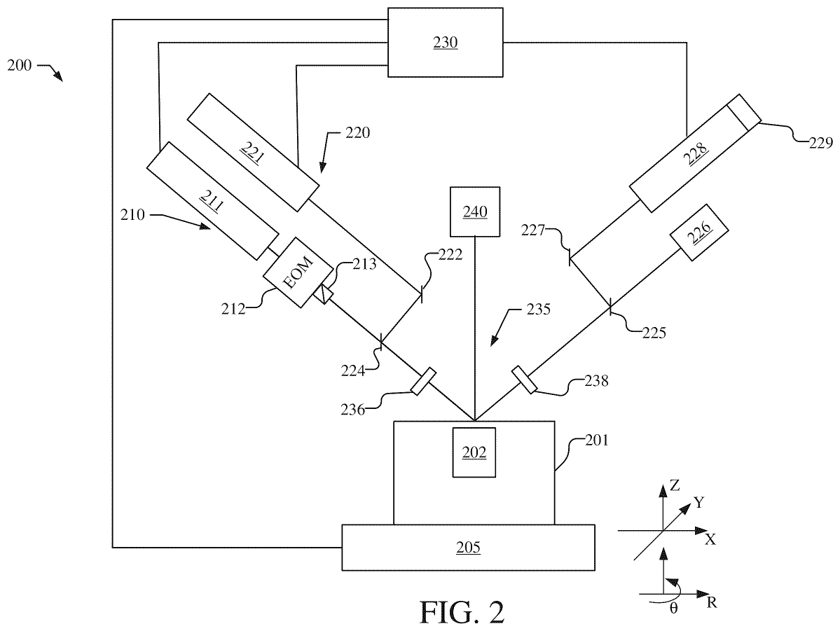

FIG. 2 illustrates a block diagram of another example opto-acoustic metrology device 200 that is configured to perform on-the-fly measurements with a single fixed pump-probe delay, as discussed herein.

As with metrology device 100, shown in FIG. 1, metrology device 200 is configured to perform on-the-fly measurements with a single fixed pump-probe delay by scanning the sample 201, e.g., by producing relative motion between the sample 201 and the optical head 235, which may be generally illustrated as including the focusing unit with lenses 236 and 238, but in some implementations may include additional components of or the entirety of the metrology device 200. For ease of reference, the scanning of the sample 201 may be described herein as movement of the sample 201 relative to the optical head 235, but it should be understood that scanning of the sample 201 may be performed by any relative movement between the sample 201 and the optical head 235. For example, the sample 201 may be held on a stage 205 that includes or is coupled to one or more actuators configured to move the sample 201 relative to the optical head 235 so that multiple locations in the region of interest on the sample 201 may be measured. The stage 205, for example, may be capable of horizontal motion in either Cartesian (i.e., X and Y) coordinates, or Polar (i.e., R and θ) coordinates or some combination of the two. The stage 205 may also be capable of vertical motion along the Z coordinate. As discussed above, the sample 201 may be scanned, e.g., using a raster scan strategy, a radial scan strategy, or any other desired scan strategy.

The device 200 includes a pump arm 210 that includes pump laser 211 (also referred to herein as an excitation laser), a probe arm 220 that includes a probe laser 221 (also referred to herein as a detection laser), and optics, such as turning mirror 222 and beam splitter 224. The device 200 further includes lenses 236 and 238, filters, polarizers and the like (not shown) that direct light from the pump and probe lasers 211, 221 to the sample 201 that includes a buried structure 202 to be detected or imaged. The device may further include an optical modulator 212, e.g., such as an electro-optic modulator (EOM) and polarizer 213, to modulate the pump pulses in the pump arm with a modulation frequency. In some implementations, the optical modulator may be located in the probe arm 220 or both the pump arm and probe arm may include optical modulators that operate at different modulation frequencies.

The device 200 includes optics, such as lens 236, that may be configured to adjust the spot sizes of the pump beam and probe beam. The spot sizes of the respective beams may be similar or dissimilar. For example, the optics, such as lens 236, may be configured to irradiate the sample 201 with the pump beam and the probe beam which may be coincident at the same measurement location on the sample 201. The illumination spot of the pump and probe beams produced by lens 236 is scanned over the surface of the sample 201 during measurement by producing relative motion between the sample 201 and the optical head 235, e.g., using the stage 205 that holds the sample 201, so that various locations on the sample 201 are measured. Similar to metrology device 100, discussed in reference to FIG. 1, the spot size produced by the lens 236 may be comparable to the effective pixel size produced the continuous relative movement of the sample 201 and optical head 235 of the metrology device 100 during a scan of the sample 201. In some implementations, the lens 236 may generate a line shaped illumination spot with a length that is orthogonal to the direction of travel of the scan.

The device 200 may include optics such as beam splitter 225 and turning mirror 227 and may include a beam dump 226 for capturing radiation from the pump laser returned from the sample 201. The device 200 includes a detector 228 that detects a change in reflectivity or surface deformation of the sample 201 from the reflected probe beam at the fixed pump-probe delay, and by collecting measurements at a plurality of adjacent locations, changes in the reflectance of the sample 201 at the fixed pump-probe delay may be recorded as a function of position on the sample 201. The detector 228 may be a photodetector or a multi-pixel array of photodetectors. For example, if a line shaped illumination spot is used, the detector 228 may include a multi-channel linear detector array and the reflected light from the illuminated line is imaged on the linear detector array. An image of the sample 201 may be generated by scanning the sample 201, e.g., by producing relative motion between the sample 201 and the optical head 235, to perform measurements at each separate measurement location during the scan.

In some implementations, the detector 228 may be coupled to a demodulator 229, such as a lock-in amplifier that is configured for phase locking during acquisition of signals. In some implementations, the detector 228 may be a lock-in camera that includes a multi-pixel array and independent phase locking for each pixel in the multi-pixel array. The phase locking is used to demodulate the received probe beam based on the frequency of the intensity modulation of the pump beam, or the combination of frequencies in both the pump beam and probe beam if the probe beam is also modulated. In implementations in which both the pump pulses in the pump beam and probe pulses in the probe beam are modulated with two different frequency combs (e.g., by modulators in both pump arm 210 and probe arm 220), the phase locking may be used to demodulate the combination, e.g., sum or difference, of the frequencies. Moreover, the phase locking may generate in-phase measurements and quadrature measurements from the images. The detector 228 records the reflectance of the sample 201 at the fixed pump-probe delay, and by collecting measurements at a plurality of adjacent locations, changes in the reflectivity or deflection of the sample 201 at the fixed pump-probe delay may be recorded as a function of position on the sample 201.

The detector 228 and actuators for controlling the relative motion of the sample 201 and the optical head 235, as well as other components of the metrology device 200, may be coupled to a processing system 230, which may be the similar to the processing system 170 discussed in reference to FIG. 1. It should be appreciated that the processing system 230 may be a self-contained or distributed computing device capable of performing computations, receiving, and sending instructions or commands and of receiving, storing, and sending information related to the metrology functions of the device.

In the depicted implementation, the pump and probe lasers 211, 221 in the implementation of the metrology device 200 shown in FIG. 2 can share at least a portion of an optical path to and from the sample 201. For example, the lasers can have a number of different relative arrangements including a configuration wherein the paths are the same, partially overlapping, adjacent, or coaxial. In some implementations, the pump and probe beams may be derived from the same pulsed laser. In some implementations, as illustrated in FIG. 2, separate lasers may be used for the pump and probe beams, e.g., separate synchronized lasers the same repetition rates may be used to produce the fixed pump-probe delay. The fixed pump-probe delay may be adjusted, e.g., between measurements, by varying the phase between the pump beam and probe beam. Additionally, in some implementations, the metrology device 200 may be switched to an asynchronous optical sampling (ASOPS) configuration in which the separate lasers may be used for the pump and probe beams with slightly different repetition rates to generate a varying pump-probe delay. In other implementations, the pump and probe lasers 211, 221 and the beam dump 226 and detector 228 do not share optical paths. For example, the pump beam from the pump laser 211 may be normally incident on the sample 201, while the probe beam from the probe laser 221 may be obliquely incident on the sample 201. The pump and probe lasers 211, 221 may be controlled directly so as to obtain the temporal spacing between the pulses of light directed to the structure 202.

It should be appreciated that many optical configurations are possible. In some configurations the pump can be a pulsed laser with a pulse width in the range of several hundred femtoseconds to several hundred nanoseconds and the probe beam is coupled to a beam deflection system. For example, in some implementations, the pump arm 210 and/or the probe arm 220 may include a mechanical delay stage (not shown) for increasing or decreasing the length of the optical path difference between the pump beam and the probe beam. The delay stage, where provided, would be controlled by processing system 230 to obtain and control the time delay between the pump and probe light pulses that are incident on the object. Many other alternative configurations are also possible. In other implementations, such as with an ASOPS configuration, the device may not include a delay stage. It should be appreciated that the schematic illustration of FIG. 2 is not intended to be limiting, but rather depict one of a number of example configurations.

In operation, the metrology device 200 directs a series of pump pulses from the pump laser 211 to the structure 202. These pulses of light are incident on the sample 201, e.g., at an angle which can be any angle between zero to 90 degrees including, for example, 45 degrees and 90 degrees). If the sample 201 includes an at least partially absorbing transducer layer, e.g., a metallic layer, above the structure 202, the pump pulses from the pump laser 211 are at least partially absorbed causing a transient expansion, i.e., acoustic signal, in the material of the transducer layer. The expansion is short enough that it induces what is essentially an ultrasonic wave that propagates vertically through the structure 202 and is reflected at each underlying interface and is returned to the top surface. Light from the pump laser 211 that is reflected from the structure 202 is passed into a beam dump 226 which extinguishes or absorbs the pump radiation.

If the sample 201 does not include a strongly absorbing material such as a metallic layer, and only includes materials that are optically transparent to the wavelengths used by the pump laser 211, there may be no (or only a minor) transient expansion, i.e., acoustic signal, that is produced. Nevertheless, a non-acoustic transient signal in the sample 201 is produced in response to the primary pump pulses and the secondary pump pulses from one or more different physical phenomena, such as thermal dissipation, electron-hole recombination (e.g., possible generated in Si), plasma diffusion, symmetry breaking at top and bottom oxide surfaces, etalon effects within a void, etc. Without a strongly absorbing material to produce an acoustic signal, the non-acoustic contributions to the return signal become more prominent and sensitive to the presence of structures, such as voids in oxide layers.

In addition to directing the operation of the pump laser 211, the processing system 230 directs the operation of the probe laser 221. Probe laser 221 directs radiation in a series of probe pulses that is incident on the sample 201, which reflect from the sample 201 and is affected by the resulting transient signals, e.g., reflected acoustic signals if the sample 201 includes a strongly absorbing material to produce acoustic signals, or the non-acoustic transient signals if strongly absorbing materials are not present in the sample 201.

The light reflected from the surface of the sample 201 is directed to the detector 228, e.g., by beam splitter 225. The reflectance of the reflected probe beam is modulated due to changes in reflectivity or surface deformation due to the reflected acoustic waves or the non-acoustic transient signals in response to the primary pump pulses and the secondary pump pulses. The detector 228 may be configured to receive and demodulate the reflected probe pulses, e.g., using the demodulator 229.

In implementations in which the detector 228 includes a multi-pixel array, the optics, such as lens 238, may adjust the magnification of the probe beam on the multi-pixel array for efficiency. The detector 228 may include the demodulator 229 that is configured for phase locking to acquire the transient signals. If the detector 228 includes the multi-pixel array, the demodulator 229 may be configured for independent phase locking for each pixel in the multi-pixel array for parallel acquisition of transient signals. In some implementations, the demodulator 229 may be independent of the detector 228, e.g., in a separate processor or Field Programmable Gate Array (FPGA) or in the processing system 230. The phase locking may be used to demodulate the frequency of the pump pulses in the received probe beam. If both the pump pulses and probe pulses are modulated a combination, e.g., a sum or difference, of the frequencies in the received probe beam may be demodulated. The detector 228 may record a change in reflectivity or surface deformation of the sample 201 at the fixed pump-probe delay, and by collecting measurements at a plurality of adjacent locations, changes in the reflectance of the sample 101 at the fixed pump-probe delay may be recorded as a function of position on the sample 101.

In addition, the metrology device 200 may be coupled with a dynamic focus control device 240 that may be configured to dynamically control the focus of the pump and probe beams on the sample 201 during the on-the-fly measurement. The dynamic focus control device 240, for example, may image the top structure of the sample 201, and may dynamically control the height (Z) of the sample with respect to the optical head 235. The dynamic focus control device 240, for example, may be the navigation channel camera.

The metrology devices 100 and 200 shown in FIGS. 1 and 2 are configured to produce on-the-fly, two-dimensional scanning, opto-acoustic measurements at a single fixed pump-probe time delay. Conventionally, opto-acoustic measurement signals are acquired over a range of pump-probe delay times, with the relative position of the sample and optical head held stationary to acquire the measurement signals over the full range of pump-prove delay times at each discrete measurement location before stepping to the next measurement location.

With the metrology devices 100 and 200 shown in FIGS. 1 and 2, relative position between the sample and optical head is continuously changed during scanning, except when moving to a new scan line, while using a single pump-probe delay time. The resulting measurement speed, accordingly, is significantly improved. For example, the acquisition time at each measurement location, i.e., effective pixel, is greatly reduced as there is no need to vary the pump-probe delay time. Moreover, with constant movement between measurements, the time due to stopping and moving between each measurement is eliminated. Additionally, with proper selection of the fixed pump-probe delay time, e.g., the delay is sensitive to the object to be detected and measured, the resulting measurements obtained from a plurality of locations is accurate.

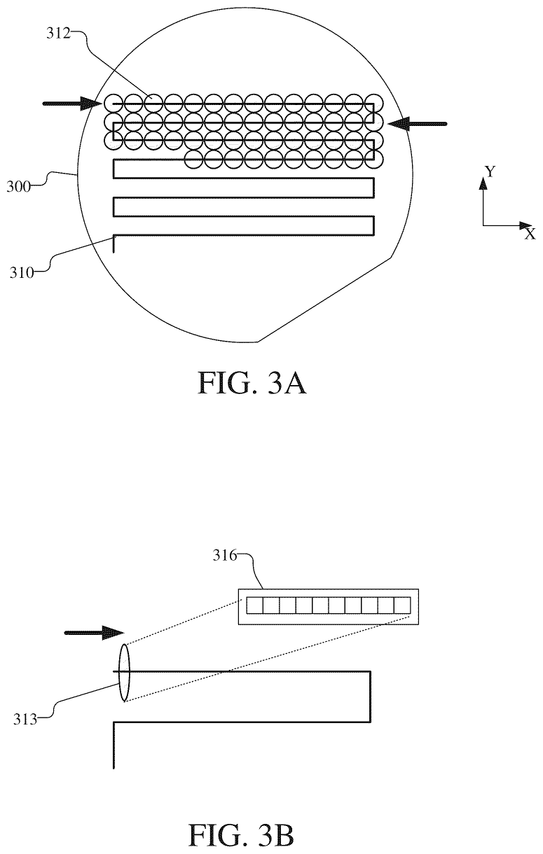

FIGS. 3A and 3B, by way of example, illustrate linear relative movement of the sample and the optical head that may be used to scan the opto-acoustic measurement of the sample. FIG. 3A, for example, illustrates a raster scan pattern 310 on a sample 300 in which opto-acoustic measurements are performed during a continuous linear scan, e.g., at constant speed, along the X direction, before moving in an orthogonal direction, along the Y direction, to prepare for the next linear scan in the opposite direction. The opto-acoustic measurement spots are illustrated as grey spots 312 along the raster scan pattern 310, where the effective pixel size of each measurement location along the direction of travel (along the X axis) is defined by the sample speed(S) and acquisition time (T) required for a single data point, e.g., pixel size=S*T as discussed above, and orthogonal to the direction of travel (along the Y axis) is defined by the spot size of the pump and probe beams, which should be the same as the raster increment distance (I), i.e., the spacing between adjacent scan lines. FIG. 3A illustrates the measurement spots 312 as circular. FIG. 3B, on the other hand, illustrates a line shaped illumination spot 313, with a line width that is comparably to the effective pixel size (S*T) and a line length (I) that is orthogonal to the direction of travel of the scan. As illustrated in FIG. 3B, the reflected light from the line shaped illumination spot 313 may be imaged on a multi-channel linear detector array 316 that includes multiple pixels to acquire signals at a plurality of locations along the line shaped illumination spot 313. Individual pixel acquisition triggers are provided by the moving stage for the sample (or optical head) and is synchronized with the sample position.

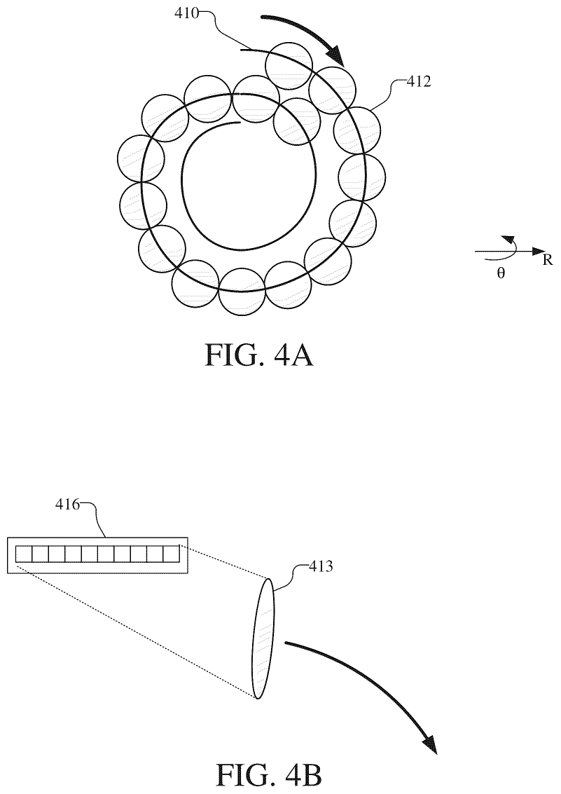

FIGS. 4A and 4B, by way of example, illustrate rotational relative movement of the sample and the optical head that may be used to scan the opto-acoustic measurement of the sample. FIG. 4A illustrates a radial scan pattern 410 in which opto-acoustic measurements are performed during a continuous spiral scan, e.g., at constant rotational speed, in the θ direction, while moving radially in the R direction. The radial movement, for example, may be produced via coordinated movement of the x/y stage or the R θ stage. For a radial scan, the opto-acoustic measurements are illustrated as grey spots 412 along the radial scan pattern 410, where the effective pixel size along the direction of travel (in the θ direction) is defined by the radius (r), angular velocity (ω), and acquisition time (T) required for a single data point, e.g., pixel size=r*ω*T. The pixel size orthogonal to the direction of travel (in the R direction) is defined by the spot size, which may be equal to the radial increment distance (I), e.g., the spacing between loops of the spiral. FIG. 4A illustrates the measurement spots 412 as circular. FIG. 4B, on the other hand, illustrates a line shaped illumination spot 413, with a line width that is comparably to the effective pixel size (S*T) and a line length (I) that is orthogonal to the direction of travel of the scan. As illustrated in FIG. 4B, the reflected light from the line shaped illumination spot 413 may be imaged on a multi-channel linear detector array 416 that includes multiple pixels to acquire signals at a plurality of locations along the line shaped illumination spot 413. The rotational and linear movement during the radial scan is coordinated to maintain a constant angular velocity (ω) and to maintain a constant radial increment distance (I) during the scan to ensure a constant effective pixel size and acquisition time. Individual pixel acquisition triggers are provided by the moving stage for the sample (or optical head) and is synchronized with the sample position.

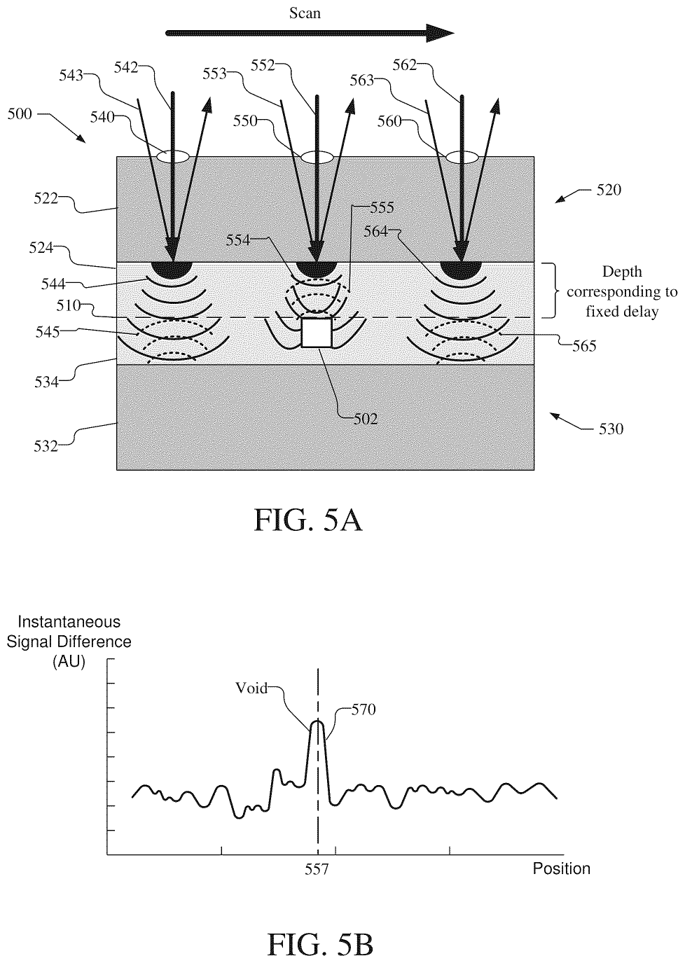

FIGS. 5A and 5B illustrate the detection of buried structures in a sample having one or more metallic layers using two-dimensional lateral scanning of opto-acoustic measurements at a single fixed pump-probe time delay. The opto-acoustic measurements, for example, acquire reflectance measurements produced in response to acoustic transient signals at a single time delay for a plurality of measurement locations. FIG. 5A illustrates a sample 500 that is formed by two bonded wafers 520 and 530 with a buried structure 502, disposed between wafers 520 and 530. The buried structure 502, for example, may be a void or other type of inclusion, and is sometimes referred to herein as void 502, but it should be understood that the buried structure 502 may be a solid structure. Wafer 520, for example, may include a silicon substrate 522 that may have a thickness of 675 μm thick, which serves as a top layer of the sample 500, and a metallic layer 524, which may be, e.g., copper (CU), tungsten (W), or titanium (Ti), and may have a thickness of 50 nm. Wafer 530 may similarly include a metallic layer 534, which may be, e.g., CU, W, or Ti, and may have a thickness of 50 nm, on a silicon substrate 532 that may have a thickness of 675 μm thick, that serves as a bottom layer of the sample 500. Layers 532 and 534 form interface. The metallic layers 524 and 534 are bonded together at an interface as illustrated by line 510, with a void 502 disposed therebetween.

FIG. 5A further illustrates the measurement of acoustic transient signals at three different locations 540, 550, and 560 on the sample 500 during a continuous scan across the sample. It should be understood that measurement locations 540, 550, and 560 are illustrated as separated in FIG. 5A, but the size and location of the measurement locations are related to the effective pixel size produced by the continuous relative movement of the sample and the optical head. Moreover, it should be understood that the measurement of the acoustic transient signals at locations 540, 550, and 560 occur sequentially during the lateral scan of the sample. In FIG. 5A, the measurement location 550 includes a buried void 502, while measurement locations 540 and 560 do not include a buried void. Acoustic transient signals are generated due to the presence of an optically opaque material, e.g., metallic layer 534.

At locations 540, 550, and 560, illumination from the pulses in the pump beam 542, 552, and 562 are illustrated as the normally incident solid arrows. The pump beams 542, 552, and 562, for example, may use infrared wavelengths, that penetrate the silicon substrate 522 without significant absorption, but when incident on the metallic layer 524 produce transient expansions of the metallic layer 524 at the interface with the silicon substrate 522, generating acoustic perturbations 544, 554, and 564, respectively, as illustrated by solid curved lines.

The acoustic perturbations 544, 554, and 564 propagate through the metallic layer 524 over time. At locations 540 and 560, the acoustic perturbations 544 and 564 propagate until it is at least partially reflected at the interface between the metallic layer 534 and the silicon substrate 532 and is returned to the surface of the metallic layer 524 after a delay d1 as reflected acoustic perturbations 545 and 565, as illustrated by dotted curved lines.

At location 550, which includes the void 502, a portion of the acoustic perturbation 554 is reflected at the interface of the metallic layer 524 and the void 502 and is returned to the surface of the metallic layer 524 after a delay d2 as reflected acoustic perturbations 555, as illustrated by dotted curved lines.

The reflectance at locations 540, 550, and 560 is measured by probe beams 543, 553, and 563, which are illustrated as being incident on and reflected by the sample 500 at a non-normal angle of incidence. It should be understood, however, that the probe beams 543, 553, and 563 may be co-linear with pump beam 542, 552, and 562, or if desired, the pump beam 542, 552, and 562 may be incident on the sample 500 at a non-normal angle of incidence and the probe beams 543, 553, and 563 may be incident on and reflected by the sample 500 at a normal angle of incidence. The reflectance of the sample, e.g., at the interface of the metallic layer 524 and the silicon substrate 522 as measured by probe beams 543, 553, and 563 at locations 540, 550, and 560 is altered due to changes in reflectivity or surface deformation caused by the reflected transient perturbations, e.g., by the reflected acoustic perturbations 545, 555, and 565, respectively.

As discussed above, each pulse in the probe beams 543, 553, 563 has a fixed pump-probe time delay with respect to a corresponding pulse in the pump beams 542, 552, and 562. The fixed pump-probe time delay, for example, may be set by the optical delay 132 in metrology device 100 or the phase delay between pulses in synchronized pump laser 211 and probe laser 221 in metrology device 200. The pump-probe delay may be selected to correspond to the expected depth of the void 502, i.e., the expected time for an acoustic perturbation to propagate to the void and the reflected perturbation to be returned. The pump-probe delay time may be varied between measurements to ensure sensitivity to the presence of the void 502. Thus, the reflected acoustic perturbation 555 at location 550 will be returned to the surface of the metallic layer 524, i.e., the interface between metallic layer 524 and the silicon substrate 522, when a pulse from the probe beam 553 is incident on the surface of the metallic layer 524. The reflected acoustic perturbations 545 at location 540 and the reflected acoustic perturbations 565 at location 560, however, will be returned to the surface of the metallic layer 524, i.e., the interface between metallic layer 524 and the silicon substrate 522, after the pulse from the probe beams 543 and 563 are incident on the surface of the metallic layer 524. Accordingly, at location 550, the pulses in the probe beam 553 will be modulated due to changes in reflectance caused by the reflected acoustic perturbations 555 from the void 502, but at locations 540 and 560, the pulses in the probe beams 543 and 563 will receive little or no modulation due to changes in reflectance caused by reflected acoustic perturbations 545 and 565 from the interface between the metallic layer 534 and the silicon substrate 532. By demodulating the probe beams 543, 553, and 563, the presence of an acoustic transient signal produced in response to the pump pulses may be determined.

FIG. 5B illustrates an example graph of the acoustic transient signals 570 received during the opto-acoustic measurement scan of locations 540, 550, and 560 in FIG. 5A at a fixed pump-prove delay. In the graph of FIG. 5B, the X axis represents the position of the scan, and the Y axis represents the instantaneous signal difference in arbitrary units (AU). The instantaneous signal difference, for example, may be a differential reflectivity or change in reflectivity measurement (AR/R) or surface or interface deflection measurement. The transient signals 570 are in response to acoustic signals generated in the sample during the scan over locations 540, 550 and 560 (and locations in between) in response to the pump beam as detected by the probe beam after the fixed delay. It should be understood that the raw transient signals from a sample that includes a metallic layer or other strongly absorbing material may be a combination of an acoustic signal and a background signal, e.g., produced by thermal dissipation.

As illustrated in FIG. 5B, the presence of a void or lack of a void is easily identified from the acoustic transient signal 570. As can be seen, the acoustic transient signal 570 does not significantly change, except where a structure, such as void 502, is present, as identified by the peak at position 557 in signal 570. The presence of the void or lack of void may be determined based on differences in the signal profile over a plurality of measurement positions. For example, as illustrated in FIG. 5B, at position 557, the acoustic transient signal 570 experiences a peak, while elsewhere the acoustic transient signal 570 has little change, except noise. Based on changes in the acoustic transient signals 570 over the multiple measurement positions, the presence of the void 502 at location 550 can be detected. Thus, by a judicious selection of the fixed pump-probe delay, the acoustic transient signal 570 will be sensitive to the presence of the void 502, and based on the resulting acoustic transient signal 570 over multiple positions, the presence of the void 502 may be detected. Moreover, an image of the sample 500, including the presence of absence of buried structures, such as void 502 may be generated based on the resulting acoustic transient signal at a fixed pump-probe delay from the multiple locations, e.g., by laterally scanning the measurement location over the sample.

In some implementations, the opto-acoustic metrology device may be configured to perform on-the-fly measurements with two separate but fixed pump-probe delay times while scanning the sample, as discussed herein.

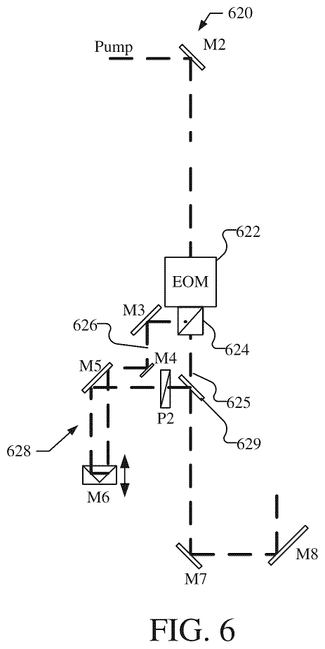

FIG. 6, by way of example, illustrates pump arm 620 that may be used in the metrology device 100 or metrology device 200 shown in FIGS. 1 and 2 and that splits a pump beam into a primary pump beam and a secondary pump beam with two different fixed pump-probe delay times. As illustrated, the pump beam in the pump arm 620 may be directed to a pump beam optical modulator 622, which for example, may be an electro-optic modulator (EOM) or other suitable modulator, to intensity modulate the pump beam at a desired frequency. The modulated pump beam is received by a pump beam splitter 624 that splits the modulated pump beam into a primary pump beam that travels along a primary pump beam path 125 and a secondary pump beam that travels along a secondary pump beam path 626. The primary pump beam and the secondary pump beam are both intensity modulated due to the pump beam optical modulator 622, but the intensity modulation of the secondary pump beam is 180 degrees out of phase with respect to the primary pump beam due to the pump beam splitter 624.

Unlike pump arm 120, shown in FIG. 1, which rejects the secondary pump beam, in FIG. 6, the secondary pump beam is recombined with the primary pump beam by a beam splitter 629. As illustrated, for example, the secondary pump beam travels along secondary pump beam path 626, where it is directed by various directional mirrors, e.g., M3 and M4, to an optical delay 628 that produces a delay between the pulses in the primary pump beam and the secondary pump beam. The optical delay 628, for example, is illustrated by mirrors M5 and M6. The mirror M6 may be a retroreflector. In some implementations, the mirror M6 may be coupled to an actuator or voice coil that may be controlled to vary the delay produced by the optical delay 628. During measurements, the delay produced by the optical delay 628 is fixed so that the time delay between the pulses in the primary pump beam and the secondary pump beam is constant. The optical delay 628 in the secondary pump beam path 626 may be controlled to set the delay difference with respect to the primary pump beam path 625, e.g., to improve signal sensitivity. Due to the extra reflective elements in the secondary pump beam path 626, such as mirrors M3, M4, M5, and M6, the total path length for secondary pump beam is greater than the total path length for the primary pump beam. Accordingly, pulses in the primary pump beam and corresponding pulses in the probe beam have a different pump-probe delay time than the pulses in the secondary pump beam and the same corresponding pulses in the probe beam.

Additionally, the series of reflections in the secondary pump beam path 626, e.g., by mirrors M3, M4, M5, and M6, may be configured so as to produce a 90 degree rotation in the orientation of the polarization of the secondary pump beam so that the primary pump beam and secondary pump beam have the same polarization orientation when combined by the beam splitter 629. In some implementations, additional mirrors may be located in the primary pump beam path 625 between the pump beam splitter 624 and the beam splitter 629 to assist in controlling the relative polarization orientations of the primary pump beam and secondary pump beam as well as controlling the first delay in the primary pump beam path 625. Additionally, a polarizer P2 may be located in the secondary pump beam path 626 before beam splitter 629 to ensure the primary pump beam and secondary pump beam have the same polarization orientation. Upon recombination by the beam splitter 629, the primary pump beam and secondary pump beam are co-linear, have the same polarization, are both are intensity modulated at the same frequency but are opposite in phase, and the pulses in the secondary pump beam are delayed with respect to the pulses in the primary pump beam, i.e., the pulses in the primary and second pump beams have different pump-probe delay times with respect to pulses in the probe beam.

The first fixed time delay between the primary pump pulses and the probe pulses and the second fixed time delay between the secondary pump pulses and the probe pulses may be selected to detect buried structures at different depths in a sample, or to be sensitive to the decay rate of non-acoustic transient perturbation signals. For example, each pulse in the probe beam will detect transient perturbation signals caused by both the primary pump pulses and the secondary pump pulses, e.g., caused by reflected acoustic transient signals from depths in the sample corresponding to the different delay times or caused by decaying non-acoustic transient signals. The demodulator, e.g., demodulator 162 or 229 shown in FIGS. 1 and 2, respectively, demodulate the received probe beam based on the frequency of the intensity modulation of the pump beam to determine an instantaneous signal difference from the primary and secondary pump beams, which may be used to differentiate between various attributes or traits of the transient signals from different locations in the sample. The attributes or traits of the transient signals from different locations may be used to determine whether the measurements are carried out at locations with voids or locations without voids. The transient signals, for example, may be acoustic transient signals or non-acoustic transient signals, i.e., signals in which contributions from any acoustic signal is less than the contributions produced by other physical phenomena such as one or more of thermal dissipation, electron-hole recombination, plasma diffusion, symmetry breaking at top and bottom oxide surfaces, etalon effects, etc. The underlying structures may be detected based on a comparison of the signal difference produced by the transient signals from the plurality of different measurement locations produced during the scan.

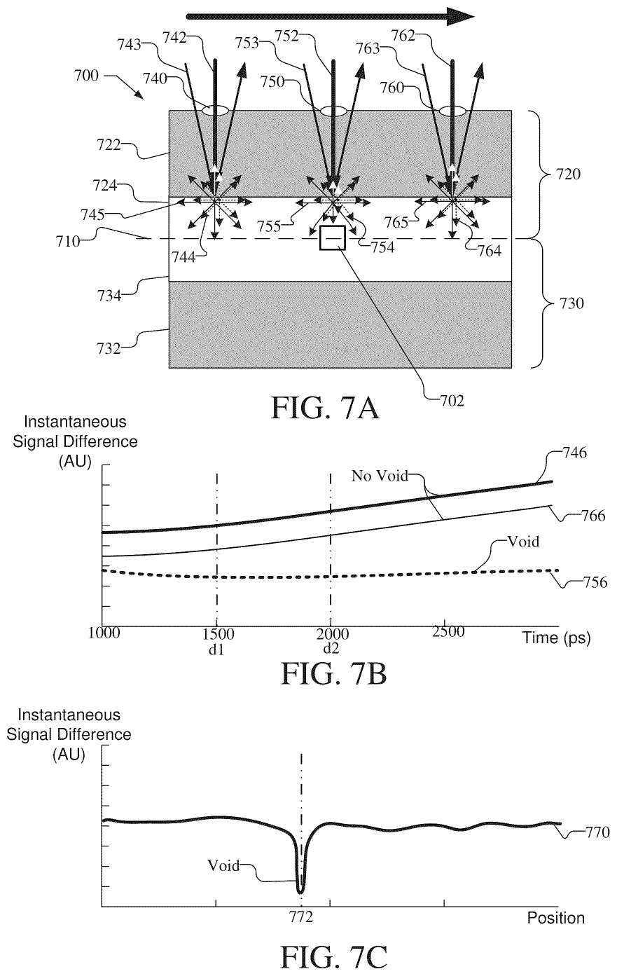

FIGS. 7A, 7B, and 7C illustrate the detection of buried structures in a sample having no metallic layers (or other strongly absorbing material capable of producing acoustic signals) using two-dimensional scanning of opto-acoustic measurements at two separate fixed pump-probe time delays. The opto-acoustic measurements, for example, acquire reflectance measurements produced in response to non-acoustic transient signals. The reflectance measurements produced in response to the non-acoustic transient signals, for example, may be due to changes in reflectivity, although it may be possible that the non-acoustic transient signals may also or alternatively cause some changes in surface deformation, which might be detected in the reflectance measurements. FIG. 7A illustrates a sample 700 that is similar to sample 500 shown in FIG. 5A, except that sample 700 includes a silicon oxide (SiO₂) instead of a metallic layer. As illustrated, sample 700 is formed by two bonded wafers 720 and 730 with a buried structure in the form of a void 702 disposed between. Wafer 720, for example, includes a silicon substrate 722 that may have a thickness of 775 μm thick, which serves as a top layer of the sample 700, and a SiO₂ layer 724, which may have a thickness of 50 nm. Wafer 730 similarly includes a SiO₂ layer 734, which may have a thickness of 50 nm, on a silicon substrate 732 that may have a thickness of 775 μm thick, that serves as a bottom layer of the sample 700. The SiO₂ layers 724 and 734 are bonded together as illustrated by line 710, with a void 702 disposed therebetween.

FIG. 7A further illustrates the measurement of non-acoustic transient signals at three different locations 740, 750, and 760 on the sample 700 during a continuous scan of the sample. It should be understood that measurement locations 740, 750, and 760 are illustrated as separated in FIG. 7A, but the size and location of the measurement locations are related to the effective pixel size produced by the continuous relative movement of the sample and the optical head. Moreover, it should be understood that the measurement of the acoustic transient signals at locations 740, 750, and 760 occur sequentially during the lateral scan of the sample. In FIG. 7A, the measurement location 750 includes a buried void 702, while measurement locations 740 and 760 do not include a buried void. The sample 700 includes only optically transparent layers, i.e., there is no strongly absorbing materials that generates acoustic signals in response to the pump illumination, and accordingly, non-acoustic transient signals are produced and measured at locations 740, 750, and 760.

At locations 740, 750, and 760, illumination from the pulses in the pump beams 742, 752, and 762 are illustrated as the normally incident solid arrows. The pump beam 742, 752, and 762 may be a combination of the primary pump beam and secondary pump beam, as discussed above. The pump beams 742, 752, and 762 may use infrared wavelengths, that penetrate the silicon substrate 722 without significant absorption. The SiO₂ layers 724 and 734 are not strongly absorbing material and do not produce transient expansions in response to the pulses in the pump beams 742, 752, and 762, and thus no (or little) acoustic signals are generated in the SiO₂ layers 724 and 734. The pump beams 742, 752, and 762, however, produce non-acoustic transient perturbations, e.g., due to the absorption of the pulses from the pump beams via multi-photon ionization or due to distortion of the sample material properties at the interface. Non-acoustic transient perturbations 744, 754, and 764 are produced in response to the primary pump beam at locations 740, 750, and 760, respectively, as illustrated by outwardly radiating solid arrows and non-acoustic transient perturbations 745, 755, and 765 are produced in response to the secondary pump beam at locations 740, 750, and 760, respectively, as illustrated by outwardly radiating dotted arrows. The non-acoustic transient perturbations 744/745, 754/755, and 764/765 are produced in response to the primary pump pulses and secondary pump pulses in the pump beams 742, 752, and 762, respectively, and are generated by non-acoustic physical phenomena, such as one or more of thermal dissipation, electron-hole recombination, plasma diffusion, symmetry breaking at top and bottom oxide surfaces, etalon effects within the void 702, etc. Unlike the acoustic transient perturbations illustrated in FIG. 5A, the non-acoustic transient perturbations 744/745, 754/755, and 764/765 are not reflected and returned by structures, but instead are produced in response to, e.g., absorption of the pulses from the pump beams, and decay over time. The presence of structures, such as void 702, affect the rate of decay of the non-acoustic transient perturbations 744/745, 754/755, and 764/765.

The reflectance at locations 740, 750, and 760 is measured by pulses in the probe beams 743, 753, and 763, which are illustrated as being incident on and reflected by the sample 700 at a non-normal angle of incidence. It should be understood, however, that the probe beams 743, 753, and 763 may be co-linear with pump beams 742, 752, and 762, or if desired, the pump beams 742, 752, and 762 may be incident on the sample 700 at a non-normal angle of incidence and the probe beams 743, 753, and 763 may be incident on and reflected by the sample 700 at a normal angle of incidence. The reflectance of the sample, e.g., at the interface of the SiO₂ layers 724 and the silicon substrate 722 as measured by probe beams 743, 753, and 763 at locations 740, 750, and 760 is modulated due to changes in reflectivity of the SiO₂ layers 724 caused by the non-acoustic transient perturbations 744, 754, and 764. In some situations, the reflectance of the sample may also or alternatively be due to changes in surface deformation. The non-acoustic transient perturbations 744/745, 754/755, and 764/765 decay over time and, accordingly, the measured reflectance produced in response to the non-acoustic transient perturbations 744/745, 754/755, and 764/765 will likewise change over time. In general, for measurements of acoustic transient signals as illustrated in FIG. 5A, the non-acoustic transient perturbations 744/745, 754/755, and 764/765 would be considered background signals and would be removed from the raw transient signal measurements. In the present implementation, however, there is no or little acoustic information, and accordingly, the raw transient signals measured and analyzed for locations 740, 750, and 760 is the non-acoustic transient perturbations 744/745, 754/755, and 764/765.

As discussed above, the pump beams 742, 752, 762 are a combination of the primary pump beam and the secondary pump beam. Each pulse in the probe beams 743, 753, 763 has a first fixed time delay with respect to a corresponding pulse in the primary pump beam and a second fixed time delay with respect to a corresponding pulse in the secondary pump beam. The non-acoustic transient perturbations 744/745, 754/755, and 764/765 produced in response to the primary pump pulses and the secondary pump pulses will be returned to the surface of the metallic layer 724, i.e., the interface between metallic layer 724 and the silicon substrate 722, when a pulse from the probe beams 743, 753, and 763 are incident on the surface of the metallic layer 724. The non-acoustic transient perturbations 744/745, 754/755, and 764/765 decay over time, and thus, the non-acoustic transient perturbations 744, 754, and 764 produced in response to the primary pump pulses will be more decayed than the non-acoustic transient perturbations 745, 755, and 765 produced by the secondary pump pulses, when measured by pulses from the probe beams 743, 753, 763. Accordingly, at location 740, the pulses in the probe beam 743 will be modulated due to changes in reflectance caused by the combination of non-acoustic transient perturbations 744 and 745. Similarly, at location 760, the pulses in the probe beams 763 will be modulated due to changes in reflectance caused by non-acoustic transient perturbations 764 and 765. At location 750, the probe beam 753 will be modulated due to changes in reflectance caused by non-acoustic transient perturbations 754 and 755, which differ from non-acoustic transient perturbations 744/745 and 764/765 due to the presence of the void 702. By demodulating the probe beams 743, 753, and 763, the instantaneous signal difference produced in response to the primary pump pulses and secondary pump pulses may be determined.

FIG. 7B illustrates an example graph of the non-acoustic transient signals 746, 756, and 766 detected by probe beams 743, 753, and 763 at locations 740, 750, and 760, respectively, in FIG. 7A, if the non-acoustic transient signals were acquired at each location over a range of pump-probe delay times. In the graph of FIG. 7B, the X axis represents the delay time between the pump and probe beams in picoseconds (ps), and the Y axis represents the instantaneous signal difference in arbitrary units (AU). The measured non-acoustic transient signals 746, 756, 766 are in response to non-acoustic transient perturbations produced at locations 740, 750 and 760 in response to a single pump beam, i.e., a pump beam that does not include the secondary pump beam, and that has a pump-probe delay time that varies from 1000 ps to approximately 3000 ps. The presence of the void 702 at location 750, however, results in a difference in the non-acoustic perturbation 754 with respect to the non-acoustic transient perturbations 744 and 764 at locations 740 and 760, and accordingly, the resulting measured non-acoustic transient signals produced in response to these perturbations will likewise differ. For example, as illustrated in FIG. 7B, the non-acoustic transient signals 746 and 766 from locations 740 and 760, where no void is present, are generally similar in attributes or traits such as the shape or slope of the transient signals. In contrast, the non-acoustic transient signals 756 from locations 750, where the void 702 is present, is dissimilar as to these attributes or traits, such as the shape or slope to the non-acoustic transient signals 746 and 766 at locations 740 and 760 on the sample 700. Accordingly, analysis of the transient signals may be performed to differentiate between various attributes or traits of the transient signals from different locations. The attributes or traits of the transient signals from different locations may be used to determine whether the measurements are carried out at locations with voids or locations without voids.

When the transient signals are produced by non-acoustic perturbations, such as one or more of thermal dissipation, electron-hole recombination, plasma diffusion, symmetry breaking at top and bottom oxide surfaces, etalon effects, etc., the presence of the void or lack of void is determined based on the difference in the transients signals over a range of time delays, e.g., a plurality of points on the time delay axis. As discussed above, the pump beams 742, 752, and 762 are a combination of the primary pump beam and the secondary pump beam. By a judicious selection of the first fixed delay between the primary pump pulses and the probe pulses, e.g., delay d1 shown in FIG. 7B, and the second fixed delay between the secondary pump pulses and the probe pulses, e.g., delay d2 shown in FIG. 7B, the instantaneous signal difference produced non-acoustic transient signal 756 will significantly differ from the instantaneous signal difference produced by acoustic transient signal 746 and 766 due to the presence of the void 702, and thus based on the instantaneous signal difference, the presence of the void 702 may be determined. In some implementations, the one or both the first fixed delay and second fixed delay may be varied, e.g., by altering one or both of the probe beam paths to increase sensitivity to the instantaneous signal difference. As can be seen in FIG. 7B, the resulting difference in the signals produced in response to the first fixed time delay d1 and the second fixed time delay d2 will be different for the non-acoustic transient signals 746 and 766 from locations 740 and 760, where no void is present, and the non-acoustic transient signals 756 from locations 750, where the void 702 is present. For example, FIG. 7B illustrates the signal difference in the non-acoustic transient signals 756 from location 750 at the first fixed time delay d1 and the second fixed time delay d2 as approximately 0, while the signal difference in the non-acoustic transient signals 746 and 766 from locations 740 and 760 at the first fixed time delay d1 and the second fixed time delay d2 will be non-zero. Thus, the void 702 may be detected using instantaneous signal differencing using fixed time delays in the primary pump beam and secondary pump beam. Moreover, an image of the sample 700, including the presence of the void 702, may be generated based on the instantaneous signal differencing of non-acoustic transient signals from the multiple locations, e.g., by laterally scanning the measurement location over the sample.

FIG. 7C illustrates an example graph of the instantaneous signal difference 770 received during the opto-acoustic measurement scan of locations 740, 750, and 760. In the graph of FIG. 7B, the X axis represents the position of the scan, and the Y axis represents the instantaneous signal difference in arbitrary units (AU). The instantaneous signal difference 770 is in response to the measured non-acoustic transient signals during the scan over locations 740, 750 and 760 in response to a two pump beams, i.e., primary pump beam and secondary pump beam, with different fixed pump-probe delay times, which may be the first fixed time delay d1 and the second fixed time delay d2, illustrated in FIG. 7B. The presence of the void or lack of void may be determined based on differences in the signal profile over a plurality of measurement positions. For example, as illustrated in FIG. 7C, at position 772, the instantaneous signal difference 770 experiences a negative peak, e.g., minimum, while elsewhere the instantaneous signal difference 770 there may be little change, except noise. Based on changes in the instantaneous signal difference 770 over the multiple measurement positions, the presence of the void 702 at location 750 can be detected. Thus, by a judicious selection of the two separate fixed pump-probe delays, the instantaneous signal difference 770 will be sensitive to the presence of the void 702, and based on measurements over multiple positions, the presence of the void 702 may be detected. Moreover, an image of the sample 700, including the presence of absence of buried structures, such as void 702 may be generated based on the resulting instantaneous signal difference 770 at two fixed pump-probe delays from the multiple locations, e.g., by laterally scanning the measurement location over the sample.

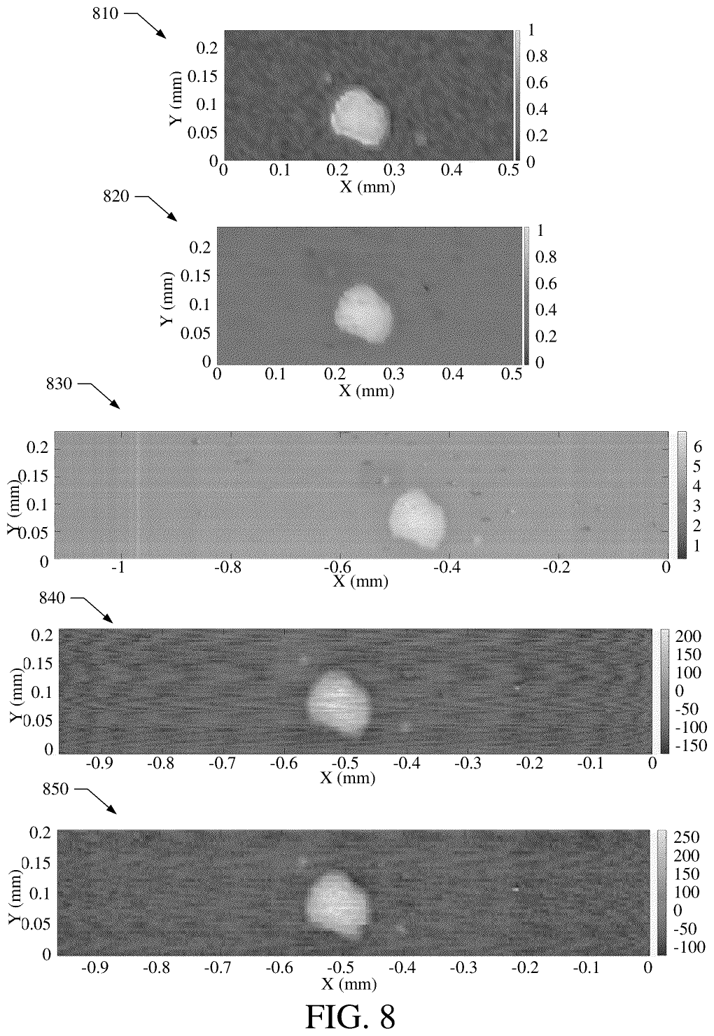

With the use of an opto-acoustic metrology device configured to perform measurements with a fixed pump-probe delay time, or two separated fixed pump-probe delay times, while scanning the sample, the signal acquisition time may be significantly reduced, while the accuracy of the detection or image is maintained. FIG. 8, for example, illustrate a plurality of images 810, 820, 830, 840, and 850 of a buried structure that is imaged using opto-acoustic measurements with a fixed pump-probe delay time. Images 810 and 820, for example, illustrated images acquired using discrete steps (stop-and-go) to scan the sample. Image 810, for example, illustrates a buried structure imaged using an opto-acoustic metrology device while moving the delay stage DS to vary the pump-probe delay time at each measurement location and scanning the sample using discrete steps (stop-and-go). Image 820 illustrates the buried structure imaged while holding the delay stage DS stationary at a fixed pump-probe delay time at each measurement location and scanning the sample using discrete steps (stop-and-go). Images 830, 840, and 850, on the other hand, illustrates images acquired on-the-fly, e.g., using constant motion during the scan of the sample. Image 830, for example, illustrates an image acquired with a 1 ms signal acquisition time (T), using 2 μm effective pixel size (step), while moving at 2 mm/s. Image 840 illustrates an image acquired with a 0.3 ms signal acquisition time (T), using 3 μm effective pixel size (step), while moving at 9 mm/s. Image 850 illustrates an image acquired with a 0.3 ms signal acquisition time (T), using 5 μm effective pixel size (step), while moving at 15 mm/s. Table 1 illustrates the measurement mode for each image and the corresponding total time required to acquire the resulting image. As can be seen, the signal acquisition time is significantly reduced using on-the-fly measurements using a fixed pump-probe delay time.

TABLE 1

| Image in | | Total |
|---|---|---|
| FIG. 8 | Measurement Mode | Time (sec) |
| 810 | DS moving (stop-and-go) | 4877 |
| 820 | DS parked (stop-and-go) | 830 |
| 830 | On-the-fly (1 ms T, 2 μm step, 2 mm/s speed) | 84 |
| 840 | On-the-fly (0.3 ms T, 3 μm step, 9 mm/s speed) | 42 |
| 850 | On-the-fly (0.3 ms T, 5 μm step, 15 mm/s speed) | 24 |

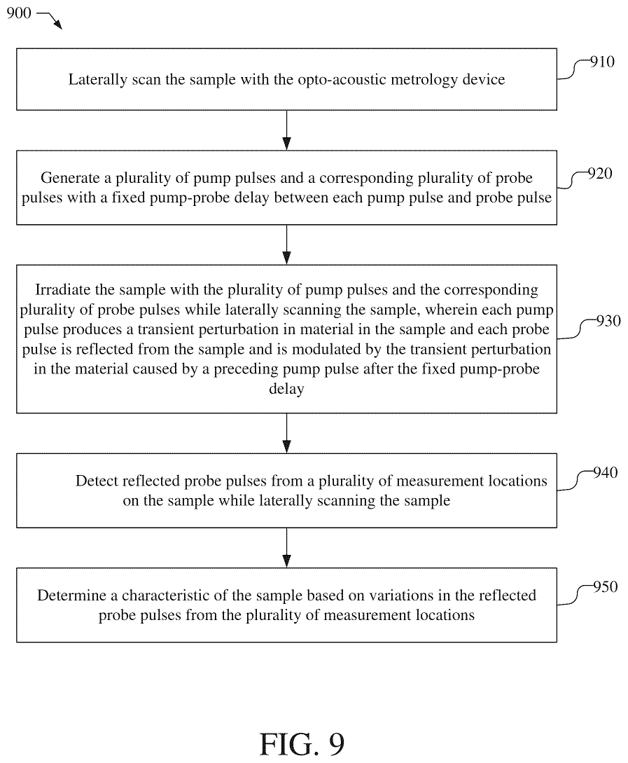

FIG. 9 is a flow chart 900 illustrating a process of characterizing a sample with an opto-acoustic metrology device using transient signals, as discussed herein. The process, for example, may be performed using metrology devices 100 or 200 shown in FIG. 1 or 2, respectively.

As illustrated, at block 910, the process includes laterally scanning the sample with the opto-acoustic metrology device, e.g., as discussed in relation to the relative movement of the sample 101 with respect to the optical head 140 in FIG. 1, the relative movement of the sample 201 with respect to the optical head 235 in FIG. 2, and illustrated in FIGS. 3A, 3B, 4A, 4B, 5A, and 7A.

In block 920, a plurality of pump pulses and a corresponding plurality of probe pulses are generated with a fixed pump-probe delay between each pump pulse and probe pulse, e.g., as discussed in relation to the light source 102, pump arm 120 and probe arm 130, and optical delay 132 in metrology device 100 shown in FIG. 1 and the light sources 211 and 221 in the pump arm 210 and probe arm 220 of the metrology device 200 shown in FIG. 2.

In block 930, the sample is irradiated with the plurality of pump pulses and the corresponding plurality of probe pulses while laterally scanning the sample, where each pump pulse produces a transient perturbation in material in the sample and each probe pulse is reflected from the sample and is modulated by the transient perturbation in the material caused by a preceding pump pulse after the fixed pump-probe delay, e.g., as discussed in relation to optical head 140 in metrology device 100 and optical head 235 in metrology device 200 and in FIGS. 5A, 5B, and 7A, 7B, and 7C.

In block 940, reflected probe pulses are detected from a plurality of measurement locations on the sample while laterally scanning the sample, e.g., as discussed in relation to optical head 140 in metrology device 100 and optical head 235 in metrology device 200 in FIGS. 1 and 2, and in FIGS. 5A, 5B, and 7A, 7B, and 7C. In some implementations, the detection of the reflected probe pulses is synchronized with a relative position of the sample and the opto-acoustic metrology device while laterally scanning the sample, e.g., as discussed in reference to FIGS. 3A, 3B, 4A, and 4B.

In block 950, a characteristic of the sample is determined based on variations in the reflected probe pulses from the plurality of measurement locations, e.g., as illustrated by the processing systems 170 and 230 in metrology devices 100 and 200 in FIGS. 1 and 2, respectively, and discussed in reference to FIGS. 5A, 5B, and 7A, 7B, and 7C. In some implementations, for example, the characteristic of the sample may be a presence or absence of one or more buried structures in the sample at a depth in the sample that corresponds to the fixed pump-probe delay, e.g., as discussed in reference to FIGS. 5A, 5B, and 7A, 7B, and 7C. In some implementations, the one or more buried structures in the sample may include one or more voids in the material of the sample, e.g., as discussed in reference to FIGS. 5A, 5B, and 7A, 7B, and 7C.

In some implementations, laterally scanning involves moving at least one of the sample and the opto-acoustic metrology device in cartesian coordinates or radial coordinates, e.g., as discussed in reference to FIGS. 3A, 3B, 4A, and 4B. For example, in some implementations, moving at least one of the sample and the opto-acoustic metrology device may include moving at least one of the sample and the opto-acoustic metrology device in a raster pattern, e.g., as discussed in reference to FIGS. 3A and 3B. For example, in some implementations, moving at least one of the sample and the opto-acoustic metrology device may include moving at least one of the sample and the opto-acoustic metrology device with a constant velocity while laterally scanning, e.g., as discussed in reference to FIGS. 4A and 4B.

In some implementations, the sample is irradiated with the plurality of pump pulses and the corresponding plurality of probe pulses by generating a line shaped illumination spot for both the plurality of pump pulses and the corresponding plurality of probe pulses, the line shaped illumination spot being oriented orthogonally to a direction of movement of at least one of the sample and the opto-acoustic metrology device while laterally scanning, e.g., as discussed in relation to optical head 140 in metrology device 100 and optical head 235 in metrology device 200 in FIGS. 1 and 2, and discussed in reference to FIGS. 3B and 4B. In some implementations, the reflected probe pulses are detected by detecting each reflected probe pulse at a plurality of locations along the line shaped illumination spot with a multi-channel linear detector array, e.g., as discussed in relation to detector 160 in metrology device 100 and detector 228 in metrology device 200 in FIGS. 1 and 2, and discussed in reference to FIGS. 3B and 4B.

In some implementations, the method may further include splitting each pump pulse into a primary pump pulse and a secondary pump pulse. Each pump pulse may be split into a primary pump pulse and a secondary pump pulse, e.g., as illustrated by the beam splitter 624 in FIG. 6, and discussed in FIGS. 7A and 7B. Each probe pulse is incident on the sample after both a primary pump pulse and a secondary pump pulse are incident on the sample and each probe pulse has a first fixed pump-probe delay with respect to the primary pump pulse and a second fixed pump-probe delay with respect to the secondary pump pulse, e.g., as discussed in relation to FIGS. 6, 7A, and 7B. Each reflected probe pulse is modulated by a first transient perturbation in the material caused by a preceding primary pump pulse after the first fixed pump-probe delay and modulated by a second transient perturbation in the material caused by a preceding secondary pump pulse after the second fixed pump-probe delay, e.g., as discussed in relation to FIGS. 6, 7A, and 7B. In some implementations, for example, the characteristic of the sample may include a presence or absence of one or more buried structures in the sample at a first depth in the sample that corresponds to the first fixed pump-probe delay and at a second depth in the sample that corresponds to the second fixed pump-probe delay, e.g., as discussed in relation to FIG. 6. In some implementations, for example, the characteristic of the sample may include a presence or absence of one or more voids in the material of the sample that is transparent to wavelengths of the pump pulses, e.g., as discussed in relation to FIGS. 6, 7A, and 7B.

The above description is intended to be illustrative, and not restrictive. For example, the above-described examples (or one or more aspects thereof) may be used in combination with each other. Other implementations can be used, such as by one of ordinary skill in the art upon reviewing the above description. Also, in the above description, various features may be grouped together to streamline the disclosure. The inventive subject matter may lie in less than all features of a particular disclosed implementation. Thus, the following aspects are hereby incorporated into the Description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method of characterizing a sample with an opto-acoustic metrology device, the method comprising:
laterally scanning the sample with the opto-acoustic metrology device;
generating a plurality of pump pulses and a corresponding plurality of probe pulses with a fixed pump-probe delay between each pump pulse and probe pulse;
irradiating the sample with the plurality of pump pulses and the corresponding plurality of probe pulses while laterally scanning the sample, wherein each pump pulse produces a transient perturbation in material in the sample and each probe pulse is reflected from the sample and is modulated by the transient perturbation in the material caused by a preceding pump pulse after the fixed pump-probe delay;
detecting reflected probe pulses from a plurality of measurement locations on the sample while laterally scanning the sample; and
determining a characteristic of the sample based on variations in the reflected probe pulses from the plurality of measurement locations.

2. The method of claim 1, wherein the characteristic of the sample comprises a presence or absence of one or more buried structures in the sample at a depth in the sample that corresponds to the fixed pump-probe delay.

3. The method of claim 2, wherein the one or more buried structures in the sample comprise one or more voids in the material of the sample.

4. The method of claim 1, wherein laterally scanning involves moving at least one of the sample and the opto-acoustic metrology device in cartesian coordinates or radial coordinates.

5. The method of claim 4, wherein moving at least one of the sample and the opto-acoustic metrology device comprises moving at least one of the sample and the opto-acoustic metrology device in a raster pattern.

6. The method of claim 4, wherein moving at least one of the sample and the opto-acoustic metrology device comprises moving at least one of the sample and the opto-acoustic metrology device with a constant velocity while laterally scanning.

7. The method of claim 1, wherein irradiating the sample with the plurality of pump pulses and the corresponding plurality of probe pulses comprise generating a line shaped illumination spot for both the plurality of pump pulses and the corresponding plurality of probe pulses, the line shaped illumination spot being oriented orthogonally to a direction of movement of at least one of the sample and the opto-acoustic metrology device while laterally scanning.

8. The method of claim 7, wherein detecting the reflected probe pulses comprises detecting each reflected probe pulse at a plurality of locations along the line shaped illumination spot with a multi-channel linear detector array.

9. The method of claim 1, detecting the reflected probe pulses is synchronized with a relative position of the sample and the opto-acoustic metrology device while laterally scanning the sample.

10. The method of claim 1, further comprising:
splitting each pump pulse into a primary pump pulse and a secondary pump pulse, wherein each probe pulse is incident on the sample after both a primary pump pulse and a secondary pump pulse are incident on the sample and each probe pulse has a first fixed pump-probe delay with respect to the primary pump pulse and a second fixed pump-probe delay with respect to the secondary pump pulse, and wherein each reflected probe pulse is modulated by a first transient perturbation in the material caused by a preceding primary pump pulse after the first fixed pump-probe delay and modulated by a second transient perturbation in the material caused by a preceding secondary pump pulse after the second fixed pump-probe delay.

11. The method of claim 10, wherein the characteristic of the sample comprises a presence or absence of one or more buried structures in the sample at a first depth in the sample that corresponds to the first fixed pump-probe delay and at a second depth in the sample that corresponds to the second fixed pump-probe delay.

12. The method of claim 10, wherein the characteristic of the sample comprises a presence or absence of one or more voids in the material of the sample that is transparent to wavelengths of the plurality of pump pulses.

13. An opto-acoustic metrology device configured for characterizing a sample, comprising:
at least one actuator configured to laterally scan the sample with the opto-acoustic metrology device;
a pump arm and a probe arm that generate a plurality of pump pulses and a corresponding plurality of probe pulses with a fixed pump-probe delay between each pump pulse and probe pulse;
at least one lens to irradiate the sample with the plurality of pump pulses and the corresponding plurality of probe pulses while laterally scanning the sample, wherein each pump pulse produces a transient perturbation in material in the sample and each probe pulse is reflected from the sample and is modulated by the transient perturbation in the material caused by a preceding pump pulse after the fixed pump-probe delay;
a detector that detects reflected probe pulses from a plurality of measurement locations on the sample while laterally scanning the sample; and
at least one processor coupled to the detector and configured to determine a characteristic of the sample based on variations in the reflected probe pulses from the plurality of measurement locations.

14. The opto-acoustic metrology device of claim 13, wherein the characteristic of the sample comprises a presence or absence of one or more buried structures in the sample at a depth in the sample that corresponds to the fixed pump-probe delay.

15. The opto-acoustic metrology device of claim 14, wherein the one or more buried structures in the sample comprise one or more voids in the material of the sample.

16. The opto-acoustic metrology device of claim 13, wherein the at least one actuator is moves at least one of the sample and the opto-acoustic metrology device in cartesian coordinates or radial coordinates.

17. The opto-acoustic metrology device of claim 16, wherein the at least one actuator is moves at least one of the sample and the opto-acoustic metrology device in a raster pattern.

18. The opto-acoustic metrology device of claim 16, wherein the at least one actuator is moves at least one of the sample and the opto-acoustic metrology device with a constant velocity while laterally scanning.

19. The opto-acoustic metrology device of claim 13, wherein the at least one lens generates a line shaped illumination spot for both the plurality of pump pulses and the corresponding plurality of probe pulses, the line shaped illumination spot being oriented orthogonally to a direction of movement of at least one of the sample and the opto-acoustic metrology device while laterally scanning.

20. The opto-acoustic metrology device of claim 19, wherein the detector comprises a multi-channel linear detector array that detects each reflected probe pulse at a plurality of locations along the line shaped illumination spot.

21. The opto-acoustic metrology device of claim 13, wherein the detector detects the reflected probe pulses synchronized with a relative position of the sample and the opto-acoustic metrology device while laterally scanning the sample.

22. The opto-acoustic metrology device of claim 13, further comprising:
a beam splitter that splits each pump pulse into a primary pump pulse and a secondary pump pulse, wherein each probe pulse is incident on the sample after both a primary pump pulse and a secondary pump pulse are incident on the sample and each probe pulse has a first fixed pump-probe delay with respect to the primary pump pulse and a second fixed pump-probe delay with respect to the secondary pump pulse, and wherein each reflected probe pulse is modulated by a first transient perturbation in the material caused by a preceding primary pump pulse after the first fixed pump-probe delay and modulated by a second transient perturbation in the material caused by a preceding secondary pump pulse after the second fixed pump-probe delay.

23. The opto-acoustic metrology device of claim 22, wherein the characteristic of the sample comprises a presence or absence of one or more buried structures in the sample at a first depth in the sample that corresponds to the first fixed pump-probe delay and at a second depth in the sample that corresponds to the second fixed pump-probe delay.

24. The opto-acoustic metrology device of claim 22, wherein the characteristic of the sample comprises a presence or absence of one or more voids in the material of the sample that is transparent to wavelengths of the plurality of pump pulses.
